(19) United States
(12) Patent Application Publication
(10) Pub. No.: US 2021/0350375 A1
(43) Pub. Date: Nov. 11, 2021

(54) DETERMINATION OF GEOGRAPHIC COORDINATES USING MACHINE LEARNING TECHNIQUES

(71) Applicant: PayPal, Inc., San Jose, CA (US)

(72) Inventors: Dongxue Li, Shanghai (CN); Lidong Ge, Shanghai (CN); Bohai Zhang, Shanghai (CN); Ying Fu, Shanghai (CN); Chunrong Fan, Shanghai (CN)

(21) Appl. No.: 17/207,096

(22) Filed: Mar. 19, 2021

(30) Foreign Application Priority Data
May 11, 2020 (CN) PCT/CN2020/089648

(51) Int. Cl. G06Q 20/40; G06N 20/00; G06N 3/04; G06F 16/29

(52) U.S. Cl. CPC G06Q 20/4015; G06F 16/29; G06N 3/049; G06N 20/00

(57) ABSTRACT

Techniques are disclosed relating to machine learning techniques for determining geographic coordinates for an address. In some embodiments, a computer system may access address information for an address that includes one or more address elements. Based on this address information, the computer system, in some embodiments, may use a machine learning model to geographic coordinates for the address. For example, a tokenization layer of the machine learning model may generate token values based on the address elements in the address, and an embedding layer of the model may create corresponding word-embedding values based on these token values. Based on the word-embedding values, an encoder layer may generate comparative vectors that may then be decoded by a decoder layer into first and second decoded values. The first and second decoded values may then be converted into geographic coordinates for the address by an output layer of the machine learning model.

### RELATED APPLICATIONS

The present application claims priority to PCT Appl. No. PCT/CN2020/089648, filed May 11, 2020, which is incorporated by reference herein in its entirety.

### BACKGROUND

### Technical Field

This disclosure relates generally to machine learning, and more particularly to machine learning techniques for determining geographic coordinates for an address, according to various embodiments.

### Description of the Related Art

In providing web services, it is often desirable to know the geographic location (specified, for example, in terms of geographic coordinates) of the users accessing the web services. For example, in some instances, such geographic location information may be used as a factor in a multi-factor authentication system used to authenticate the users of the web service. Prior techniques for determining geographic coordinates for a user's address present various technical shortcomings, however. For example, some prior techniques rely on third-party systems that maintain mass repositories of geographic coordinate information, which may expose the user's location data to the third-party service, creating data security and privacy concerns.

### BRIEF DESCRIPTION OF THE DRAWINGS

FIG. 1 is a block diagram illustrating an example server system operable to use machine learning techniques to determine geographic coordinates for an address, according to some embodiments.

FIG. 2 is a block diagram illustrating an example server system, according to some embodiments.

FIG. 3 is a block diagram illustrating an example machine learning model, according to some embodiments.

FIG. 4 is a block diagram illustrating an example encoder layer of an example machine learning model, according to some embodiments.

FIG. 5 is a flow diagram illustrating an example method for using machine learning techniques to determine geographic coordinates for an address, according to some embodiments.

FIG. 6 is a flow diagram illustrating an example method for training a machine learning model and using the trained machine learning model to determine geographic coordinates for an address, according to some embodiments.

FIG. 7 is a flow diagram illustrating an example method for using machine learning techniques to perform user authentication, according to some embodiments.

FIG. 8 is a block diagram illustrating an example computer system, according to some embodiments.

### DETAILED DESCRIPTION

“Geocoding” refers generally to the process of taking input text (e.g., an address) indicative of a physical location and, based on that input, determining the geographic coordinates (e.g., latitude and longitude) for that physical location. In providing web services, it is often desirable to know the geographic location (specified, for example, in terms of geographic coordinates) of the users accessing the web services. For example, in some instances, such geographic location information may be used as a factor in a multi-factor authentication system used to authenticate the users of the web service. Further, in some instances, this fine-grained geographic location information may be used to customize the services provided to the requesting user based on the geographic location from which the user is accessing the service. Additionally, in some instances, this geographic location information may be used to supplement a user's account information to make it more accurate.

Prior geocoding techniques present various technical shortcomings, however. For example, using third-party geocoding services (such as the Geocoding API provided by the Google™ Maps Platform) is relatively slow, requiring an API call to be sent to and serviced by the third-party service. Additionally, use of such third-party geocoding services presents security and data privacy concerns by exposing the users' physical location data to an external system. Utilizing the IP address of a user's device to determine the geographic coordinates of the user's physical location also presents certain technical shortcomings. For example, in instances in which the user is accessing the web service using a virtual private network (“VPN”), the IP address presented to the server system (e.g., specified in the header of the IP packets sent by the user's device) may not correspond to the actual geographic location of the user.

In various embodiments, however, the disclosed techniques may solve these or other technical problems by utilizing machine learning to predict the geographic coordinates for a geographic location based on address information for that geographic location. For example, consider an instance in which a disclosed computer system (e.g., a server system) receives, from a user, address information indicative of an address. In many instances, the address information will include a collection of “address elements,” which, as used herein, refers to a grouping of one or more alphanumeric characters (e.g., words or numbers) used to specify a portion of an address. Non-limiting examples of “address elements” include words or numbers used to specify a country, state or province, city, street, house or building number, apartment number, postal code, etc. For instance, as used herein, the address “10 Langdon Rd Carle Place N.Y. United States” may be said to include eight address elements: “10,” “Langdon,” “Rd,” “Carle,” Place,” NY,” “United,” and “States.” Note that, in some embodiments, the address elements in an address may be separated by a space or a particular character (e.g., a “+,” “/,” or any of various other suitable characters). Further note that, in some embodiments, a given portion of an address (e.g., a street name) may include multiple address elements.

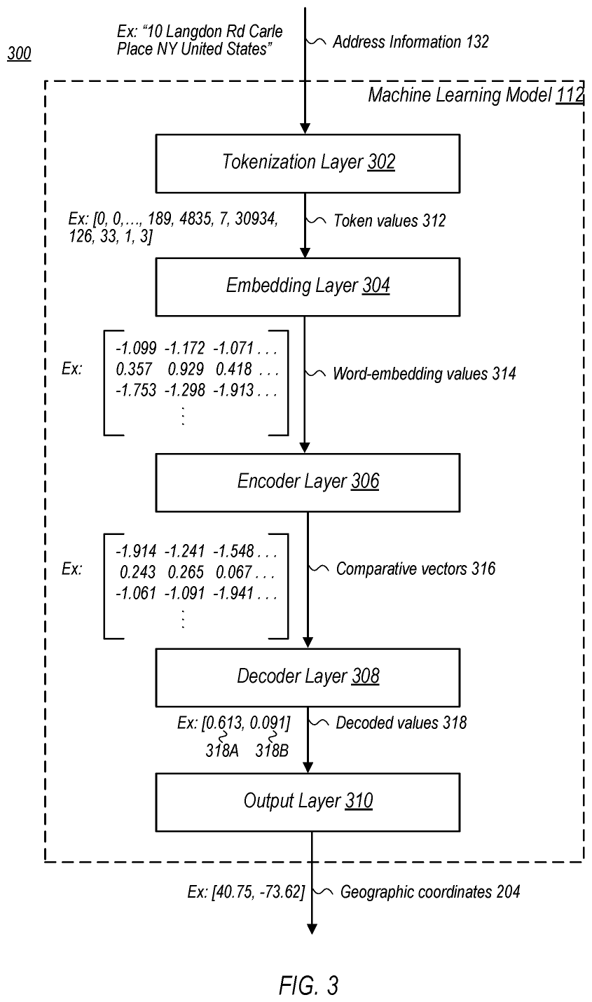

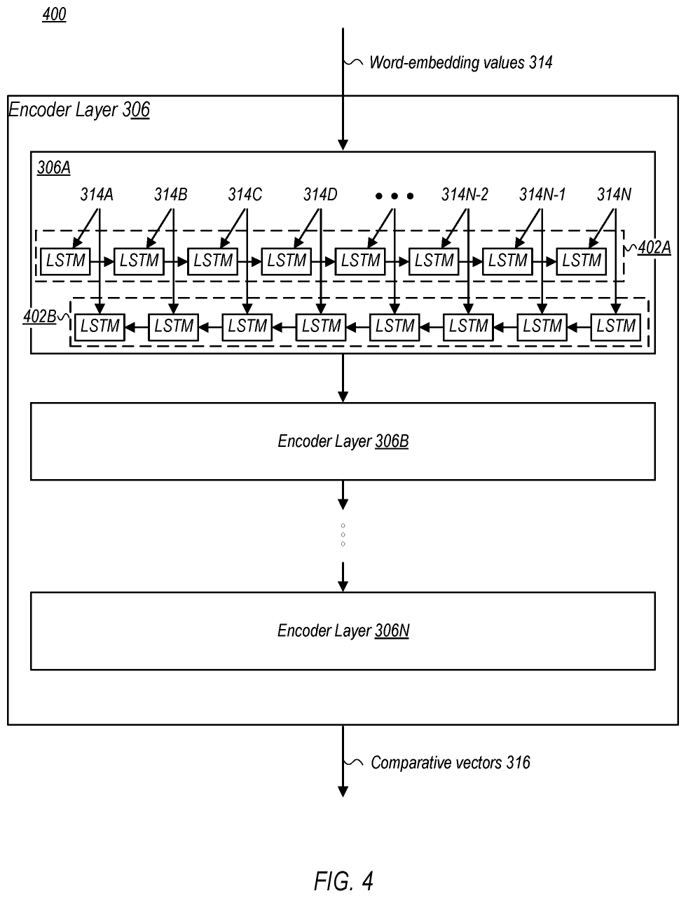

In various disclosed embodiments, the disclosed systems and methods utilize a trained machine learning model (or simply “model”) to determine geographic coordinates for an address. As used herein, “geographic coordinates” refer to one or more values (e.g., numbers, letters, symbols, etc.) used to specify the geographic location of a point on the surface of the Earth. As will be appreciated by one of skill in the art, the format of the geographic coordinates will vary depending on the geographic coordinate system used to specify the geographic coordinates. For example, one common coordinate system uses latitude and longitude values to specify the geographic location of a point. Note, however, that providing geographic coordinates using latitude and longitude values is merely one non-limiting example. Another non-limiting example for specifying geographic coordinates includes the use of three-dimensional Cartesian coordinates. Various embodiments of such a machine learning model are described in detail below with reference to FIGS. 3-4. For the purposes of the present discussion, note that the machine learning model, in various embodiments, includes multiple layers that, used together, are operable to generate geographic coordinates for a geographic location based on the address elements included in its address. For example, in some embodiments, the machine learning model includes a tokenization layer that is operable to create, for the various address elements, corresponding token values. In some embodiments, the token for a given address element is a numerical value that corresponds to a frequency with which that address element appears in a corpus of address data used to train the tokenization layer. For example, consider a situation in which the tokenization layer is trained using a corpus of address data that includes addresses located in the United States. In such a situation, the address elements “United” and “States” may appear in the corpus of training data frequently and, as such, the tokenization layer may determine, during a training phase, that such address elements are to be assigned token values that reflect this relatively high frequency of use.

Further, in some embodiments, the machine learning model may include an embedding layer that is operable to receive the token values from the tokenization layer and generate corresponding word-embedding values that represent the address elements in the address as vector quantities. As will be appreciated by one of skill in the art with the benefit of this disclosure, “word-embedding” refers to the process of representing a word or phrase (e.g., an address element) using a vector of numerical values, providing a numerical representation of the word or phrase. The machine learning model, in various embodiments, may further include an encoder layer and a decoder layer. The encoder layer, in some embodiments, is operable to receive the word-embedding values, analyze the relationship and sequence of the address elements included in the address, and generate corresponding comparative vectors based on this analysis. For example, in some embodiments, the encoder layer may be trained, using one or more backpropagation algorithms, based on a corpus of training data that includes both address information and corresponding geographic coordinates. In some embodiments, the encoder layer may be implemented using one or more layers of a bidirectional long short-term memory (“Bi-LSTM”) artificial neural network (“ANN”), though other network architectures may be used. The decoder layer, in various embodiments, is operable to receive the comparative vectors from the encoder layer and map these vectors to first and second decoded values within a predetermined range (e.g., from −1 to +1). In some embodiments, these decoded values are normalized numerical values that correspond (e.g., with a certain level of probability) to geographic coordinates for the address. The decoder layer may be implemented, in some embodiments, using a fully connected ANN, though other suitable ANN architectures may be used. Further, in various embodiments, the model includes an output layer that is operable to convert these decoded values into corresponding geographic coordinates (e.g., latitude and longitude values) for the location specified by the address, which may then be used by the server system.

The disclosed systems and methods provide various technical benefits, according to various embodiments. For example, in various embodiments, the disclosed techniques enable a computer system to determine geographic location information (e.g., coordinates) for a user's address in a manner that is both fast and accurate without exposing the users' location data to third-party services, thereby protecting the users' privacy and improving the functioning of the system as a whole. Further, rather than relying on the IP address indicated in data packets received from a user's device, the disclosed techniques are capable of determining geographic coordinates based on a user's proffered address information. This, in turn, enables the disclosed systems and methods to determine geographic coordinates for an address even in situations in which a user is access a web service via a VPN. Thus, in various embodiments, the disclosed systems and methods utilize machine learning techniques to provide a technical solution to the technical problem of determining geographic coordinates for an address, thereby improving the geocoding process and the operation of the system utilizing such geographic coordinates as a whole.

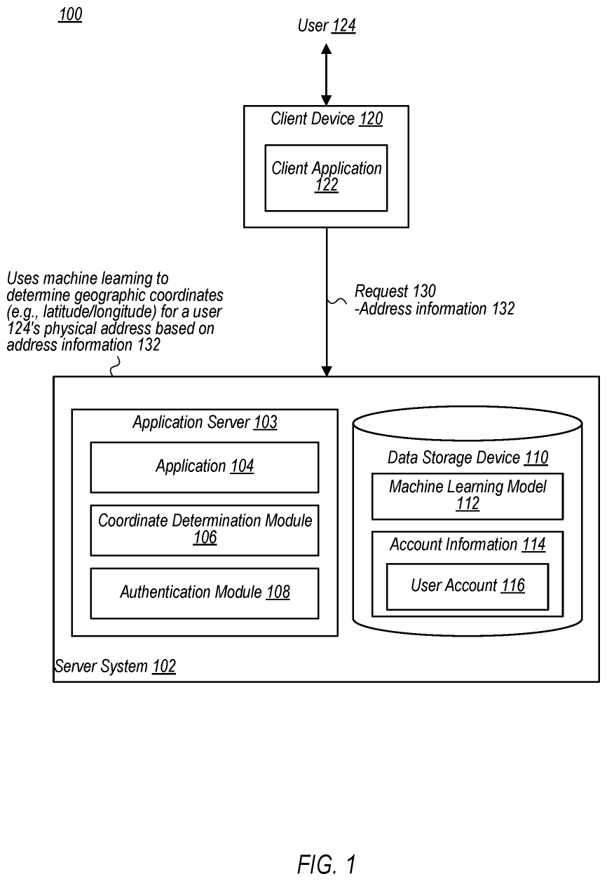

In FIG. 1, block diagram 100 depicts a server system 102 that includes application server 103 and data storage device 110. In various embodiments, server system 102 is operable to provide one or more computing resources to various end users over one or more networks (not shown, for clarity). In the depicted embodiment, for example, server system 102 includes application server 103 hosting application 104, which may be accessed by user 124 over one or more networks using client device 120. Client device 120 may be any of various suitable computing devices, such as a smartphone, laptop computer, desktop computer, tablet computer, etc. that user 124 may use to access application 104 hosted by application server 103. For example, in various embodiments, client device 120 executes a client application 122, such as a web browser or dedicated software application, that the user 136 may use to access one or more computing resources provided by application server 103, such as application 104.

In some embodiments, server system 102 is operable to provide computing resources that may be used directly by end users or integrated with (or otherwise used by) web services provided by third parties. As one non-limiting example, server system 102, in some embodiments, provides an online payment service that may be used by end users to perform online financial transactions (e.g., sending or receiving funds) or utilized by merchants to receive funds from users during financial transactions, as described above. Note, however, that this embodiment is described merely as one non-limiting example. In other embodiments, server system 102 may be used to provide any of various suitable web services (e.g., an email service, streaming media service, etc.) and application server 103 may be used to host any of various types of applications 104. Further, note that although only a single application server 103 is depicted in FIG. 1, this simplified embodiment is provided merely as a non-limiting example. In other embodiments, server system 102 may include any suitable number of application servers 103, any of which may host one or more applications 104.

In the depicted embodiment, application server 103 further hosts coordinate determination module 106, which, in various embodiments, is operable to generate geographic coordinates for a geographic location (e.g., a user 124's residence) based on the location's address. For example, in the depicted embodiment, user 124 sends, via client device 120, a request 130 to the server system 102. Request 130, in various embodiments, may be any of various types of request, such as a request to create a user account 116 associated with the server system 102 such that the user 124 may access the service(s) provided by the server system 102. In the depicted embodiment, request 130 includes address information 132. For example, as part of establishing a user account 116, the user 124 may be prompted to provide address information 132 corresponding to the user 124's residence address. In various embodiments, the coordinate determination module 106 is operable to determine geographic coordinates based on the address information 132 using machine learning model 112, the structure and operation of which, according to some non-limiting embodiments, is described in detail with reference to FIGS. 3 and 4.

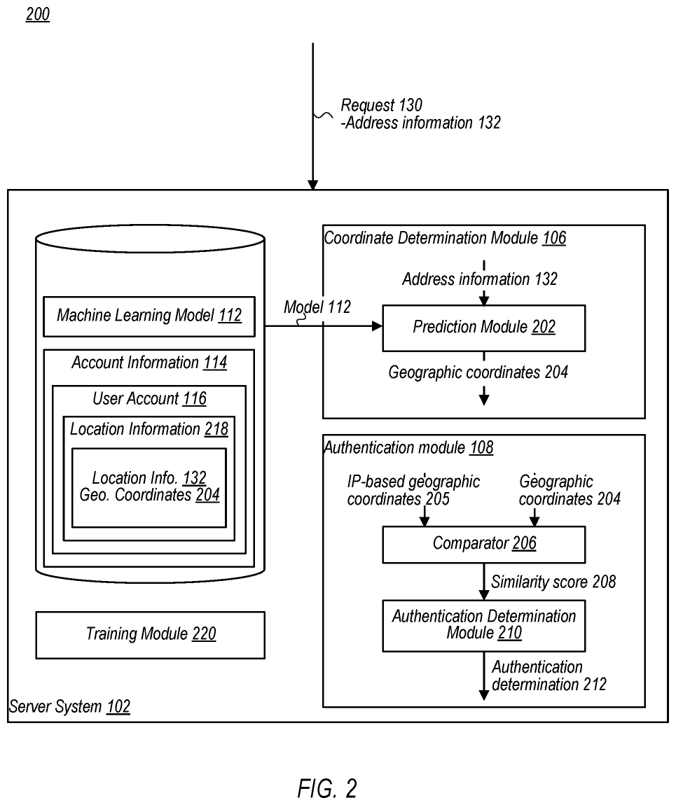

Once it has determined the geographic coordinates, server system 102 may use this information to improve the functioning of the system 102, or the services it provides, in various aspects. For example, as described below with reference to FIG. 2, server system 102, in some embodiments, includes authentication module 108 that is operable to compare the geographic coordinates generated using the machine learning model 112 against geographic coordinates determined (by server system 102 or a third-party service) based on an IP address specified in the data packets received from client device 120 (e.g., as part of the request 130). Further, in some embodiments, the geographic coordinates may be stored as part of the account information for the user 124's (new or existing) user account 116, improving the accuracy of the account information maintained for the user 124. Additionally, in some embodiments, server system 102 may use the geographic coordinates to customize or modify the appearance or functionality of the application 104 for the user 124 based on his or her location, to determine the applicable privacy regulations to apply for data associated with the user 124, or for any of various other purposes.

Note that, in some embodiments, the various elements of server system 102 may be located at the same physical location (e.g., within a single datacenter) or may be located at physical locations that are remote from one another. For example, application server 103 and data storage device 110 may be located at the same physical location or at different physical locations. In the depicted embodiment, application 104, coordinate determination module 106, and authentication module 108 are all shown being hosted by the same application server 103. Note, however, that this non-limiting embodiment is provided merely as one example and, in other embodiments, application 104, coordinate determination module 106, and authentication module 108 may be executed using separate computer systems. Further, note that, in some embodiments, one or more of application 104, coordinate determination module 106, and authentication module 108 may be implemented as microservices executed by various computer systems in the server system 102. Additionally, note that, in some embodiments, the term “server system” (such as application server 103 or server system 102) may refer to a single machine. In other embodiments, however, the term “server system” may refer to multiple machines executing (e.g., at one or more datacenters) for the benefit of a single entity. For example, in some embodiments, one or more of server system 102 or application server 103 may be implemented using multiple machines located at one or more datacenters.

Turning now to FIG. 2, a block diagram 200 illustrates an example server system 102, according to some embodiments. In the depicted embodiment, server system 102 includes data storage device 110, coordinate determination module 106, authentication module 108, and training module 220. Note that, although a single data storage device 110 is included within the server system 102 in FIG. 2, this simplified embodiment is provided merely as a non-limiting example. In other embodiments, server system 102 may include (or have access to) any suitable number of local or remote data stores, implemented using any suitable data storage technology, and that the model 112 and account information 114 may be stored by the same or different data storage devices 110, according to various embodiments.

Data storage device 110, in the depicted embodiment, stores machine learning model 112, which, as discussed below, may be used by coordinate determination module 106 to generate geographic coordinates for an address. Note that, although a single model 112 is shown in FIG. 2 for clarity, this embodiment is provided merely as one non-limiting example. In other embodiments, for example, server system 102 may maintain multiple models 112 and select one or more appropriate models 112 (or layers from one or more models 112) depending, for example, on the language in which the address information 132 is specified. Data storage device 110, in the depicted embodiment, further stores account information 114, which includes account information for user account 116. In the depicted embodiment, the user account 116 includes location information 218 for the user with which the user account 116 is associated (optionally in addition to other items of account information, not shown for clarity). As noted above, this location information 218 may be updated to include the user 124′s address information 132 and the corresponding geographic coordinates 204.

Server system 102 further includes coordinate determination module 106 that includes prediction module 202, which, in various embodiments, is operable to use machine learning techniques to determine the geographic coordinates for a location based on its an address. For example, in the depicted embodiment, server system 102 receives request 130 that includes address information 132, as discussed above. In various embodiments, prediction module 202 is operable to apply a machine learning model 112 to the address information 132 for an address to generate the geographic coordinates 204 corresponding to that address. Note that, in instances in which server system 102 utilizes different machine learning models 112 (or different versions of the same model 112) for use with different languages, coordinate determination module 106, in various embodiments, is operable to detect the language in which the address information 132 is provided and, based on the detected language, retrieve the appropriate model 112 from data storage device 110.

Server system 102 of FIG. 2 further includes authentication module 108, which, in turn, includes comparator 206 and authentication determination module 210. As noted above, in some embodiments, authentication module 108 is operable to use the geographic coordinates 204 (optionally as one of multiple factors) to determine whether to authenticate a user 124 to a user account 116 or to authorize a transaction requested by the user 124. Comparator 206, in various embodiments, is operable to compare the geographic coordinates 204 (generated by module 106) to IP-based geographic coordinates 205 that are generated based on the IP address of the client device 120 used by user 124. For example, in some embodiments, server system 102 is operable to determine the IP-based geographic coordinates 205 for a client device 120 based on the IP address specified in packet headers sent by the client device 120 to server system 102. In other embodiments, however, server system 102 may obtain the IP-based geographic coordinates 205 through use of a third-party service (not separately shown, for clarity). Comparator 206 may use any of various suitable algorithms to perform such a comparison and generate a similarity score 208 indicating a similarity between the geographic coordinates 204 generated by the coordinate determination module 106 and the IP-based geographic coordinates 205. In one non-limiting embodiment, for example, comparator 206 may calculate a percentage difference between the value of the geographic coordinates 204 and 205 and return this percent difference as the similarity score 208. Note, however, that this example is provided merely as a non-limiting embodiment and, in other embodiments, any of various suitable comparison algorithms may be used by comparator 206.

Authentication module 108 further includes authentication determination module 210, which, in various embodiments, is operable to determine whether to authenticate the user 124 to user account 116 based on similarity score 208. For example, in some embodiments, the authentication determination module 210 may determine whether to authenticate the user 124 to the user account 116 by comparing the similarity score 208 to a predetermined threshold value. As a non-limiting example, consider an embodiment in which the similarity scores 208 generated by comparator 206 correspond to a percentage difference between the coordinates 204 and 205. In this non-limiting example, authentication determination module 210 may determine that the coordinates 204 and 205 are sufficiently similar if the percentage difference between the coordinates is less than a predetermined threshold value (e.g., 3%, 2%, 1%, 0.5%, or any other suitable threshold value). Note, however, that the above example is provided merely as one non-limiting embodiment and, in other embodiments, any of various suitable techniques and algorithms for comparing the geographic coordinates 204 and 205 may be used, as desired. Further, as will be appreciated by one of skill in the art with the benefit of this disclosure, the predetermined threshold value used by authentication determination module 210 may vary depending on the technique used by comparator 206 to compare the geographic coordinates 204 and 205.

Server system 102 of FIG. 2 further includes training module 220, which, in various embodiments, is operable to train one or more layers of one or more machine learning models 112. Various aspects of the training process for model 112 are described in detail below with reference to FIGS. 3 and 4, according to some embodiments. Note, however, that, in various embodiments, machine learning model(s) 112 may be trained by the server system 102 (e.g., using training module 220) or may be trained by a third-party service (not shown in FIG. 2, for clarity) and used by server system 102 to determine geographic coordinates for locations based on those locations' addresses.

In FIG. 3, block diagram 300 depicts an example machine learning model 112, according to some embodiments. As noted above, machine learning model 112, in various embodiments, includes multiple layers that, used together, are operable to determine geographic coordinates (e.g., latitude and longitude values) for a geographic location based on its address. In the depicted embodiment, machine learning model 112 includes five layers: a tokenization layer 302, embedding layer 304, encoder layer 306, decoder layer 308, and output layer 310. Note, however, that this embodiment is provided merely as one non-limiting example. In other embodiments, machine learning model 112 may include additional, fewer, or other layers, as desired. Further note that, in some embodiments, one or more of the layers in model 112 may include multiple sub-layers and, in instances in which a given layer utilizes an ANN, multiple ANN architectures may be used within the given layer, as desired. In various embodiments, the use of machine learning model 112 may be said to generally include two phases—a “training phase,” in which various machine learning algorithms or libraries may be used to train one or more of the layers in the model 112 based on (potentially different) corpuses of training data, and a “prediction phase,” in which the trained machine learning model 112 is used to determine geographic coordinates for an address.

Tokenization layer 302, in various embodiments, is operable to generate token values based on the address elements included in an address. For example, in FIG. 3, the input address information 132 specifies the following address: “10 Langdon Rd Carle Place N.Y. United States,” which includes eight address elements. In this embodiment, tokenization layer 302 is operable to generate a token value 312 for each of the address elements included in the address specified by the address information 132. (Note, however, that in some embodiments, tokenization layer 302 may generate a different number of token values than number of address elements in an address. As one non-limiting example, in some embodiments, tokenization layer 302 may be configured to not generate token values for certain words, such as “the,” “of,” “a,” or any other suitable word, as desired.) As noted above, a “token value” for a given word refers to a value (e.g., a numerical value) that corresponds to the frequency with which the given word appears in a corpus of training data used to train the tokenization layer 302. For example, in various embodiments, tokenization layer 302 may be trained based on a corpus of address data that includes a large number (e.g., 1 million, 5 million, etc.) of example addresses. Note that, in some embodiments, the disclosed techniques include training multiple tokenization layers 302 based, for example, on the country in which the addresses in the training data are located (e.g., one tokenization layer 302 for the United States, one tokenization layer 302 for Canada, etc.) or the language in which the example addresses in the corpus of address data are provided (e.g., one tokenization layer 302 each for English, one tokenization layer 302 for German, one tokenization layer 302 for Italian, etc.). In other embodiments, however, a single tokenization layer 302 may be used.

The tokenization layer 302, in various embodiments, may use any of various suitable algorithms to analyze the corpus of training data and generate token values 312. As one non-limiting example, some disclosed embodiments use the term frequency-inverse document frequency (TF-IDF) statistical value as the token value 312 for a given address element. As will be appreciated by one of skill in the art with the benefit of this disclosure, TF-IDF is a numerical statistic that corresponds to the “importance” of a word relative to a “document” in a corpus, where the TF-IDF value increases proportionally to the number of times a word appears in the document and is offset by the number of documents in the corpus that contain that word. Note, however, that this embodiment is described merely as one non-limiting example and is not intended to limit the scope of the present disclosure. In other embodiments, various other suitable algorithms or techniques may be used to train tokenization layer 302 and generate the token values 312. In other non-limiting embodiments, tokenization layer 302 may generate token values 312 based on word frequency, CHI, the TextRank algorithm, or using any of various other suitable techniques.

Note that, in various embodiments, tokenization layer 302 may output the token values 312 as part of a vector (or other suitable data structure, such as an array) in which the token values 312 for the address elements are arranged in the same sequence as the address elements in the address specified by address information 132. Further, in some embodiments, tokenization layer 302 may pad the output vector containing the token values 312 with leading zeros so that the resulting vector is of a certain length. For example, in some embodiments, tokenization layer 302 may pad the vector such that it includes 20 values, 25 values, 30 values, etc. Note that, in some embodiments, the length to which the output vector is padded may vary depending on the language or region for which the tokenization layer 302 is trained, with longer vector lengths used for languages in which addresses typically contain a larger number of address elements.

In the depicted embodiment, the token values 312 are then passed to the embedding layer 304, which, in various embodiments, is operable to generate word-embedding values 314 based on the token values 312. Stated differently, in various embodiments, embedding layer 304 is operable to convert each token value 312 into an N-dimensional vector such that each address element in the address information 132 is represented as an N-dimensional vector. As noted above, the word-embedding values 314, in various embodiments, provide a numerical representation of the address elements in the input address. Note that, through this word-embedding process, similar address elements may be represented by the embedding layer 304 with similar word-embedding values 314, according to some embodiments.

In one non-limiting embodiment, embedding layer 304 is a model trained using the fastText library (created by the Facebook™ AI Research (“FAIR”) lab) based on a corpus of training data (e.g., Common Crawl data, Wikipedia data, or any other suitable corpus of training data), potentially in a variety of different languages. Note, however, that this embodiment is provided merely as one non-limiting example and, in other embodiments, various other algorithms or training data sets may be used. For example, in some embodiments, embedding layer 304 may generate word-embedding values 314 using a Word2vec model, using One-Hot embedding, or any other suitable technique.

As noted above, in some embodiments, each of the word-embedding values 314 may be provided as an N-dimensional vector, where N is a hyperparameter that may be adjusted as desired to improve the performance of the embedding layer 304 or the model 112. Note that, in some embodiments, embedding layer 304 generates word-embedding values 314 such that they provide a dense representation of words and the relative meanings. As a non-limiting example, in some embodiments, the embedding layer 304 may generate word-embedding values 314 as 300-dimensional vectors, though any other suitable number of dimensions may be used. Further, in some embodiments, the address word-embedding values 314 are pre-trained to have predefined meanings (such that, for example, the words “New York” and “London” result in similar word-embedding values 314), offering an improvement over sparse representation techniques (such as One-Hot embedding).

In the depicted embodiment, the word-embedding values 314 are then passed to the encoder layer 306, which, in various embodiments, is operable to generate a plurality of comparative vectors 316 based on an analysis of the word-embedding values 314. The structure and operation of the embedding layer 306, according to some non-limiting embodiments, is described in detail below with reference to FIG. 4. Note, however, that, in some embodiments, encoder layer 306 is implemented using an ANN (such as a recurrent neural network (“RNN”) or bi-directional RNN) that is operable to compare the N-dimensional word-embedding values 314 to analyze the relationship between, and sequence of, the address elements in the address specified by address information 132. For example, in some embodiments in which encoder layer 306 includes a bi-directional RNN, encoder layer 306 may “consume” the word-embedding values 314 in both a forward and backwards direction, concatenating the vectors, memorizing the word relations, and understanding the sequence meanings. Based on its analysis of the word-embedding values 314, the encoder layer 306 may, in some embodiments, generate comparative vectors 316 such that each of the comparative vectors 316 is an M-dimensional vector, where M is a hyperparameter that may be adjusted as desired to improve the performance of the encoder layer 306 or model 112. Stated differently, encoder layer 306, in various embodiments, is operable to convert each of the word embedding values 314 into a corresponding comparative vector 316. Note that, in various embodiments, “M” may be the same value or a different value from “N” such that the comparative vectors 316 may be of the same size or a different size as the word-embedding values 314.

In the depicted embodiment, the comparative vectors 316 are then passed to the decoder layer 308, which, in various embodiments, is operable to generate decoded values 318 based on the comparative vectors 316. In various embodiments, decoder layer 308 is an ANN, such as a fully connected neural network, a neural network with one or more dropout layers, a neural network with one or more batch-normalization layer, or any suitable combination thereof. That is, in some embodiments, decoder layer 308 may include one or more sub-layers, with different machine learning techniques (e.g., different ANN architectures) used at one or more of the sub-layers.

In various embodiments, decoder layer 308 and is operable to map the comparative vectors 316 to a K-dimensional vector, which may be used by the output layer 310 (discussed below) to determine the geographic coordinates 204. For example, in some embodiments, the decoder layer 308 includes one or more nodes that use non-linear activation functions (e.g., the Sigmoid function or any of various suitable alternatives) that translate the comparative vectors 316 into a vector that includes two values that are mapped into a particular range (e.g., 0-1, or any other suitable range). In this non-limiting embodiment, the first and second decoded values 318 are the numerical values of this two-dimensional vector (0.613 and 0.091, respectively, in the embodiment depicted in FIG. 3). Note, however, that this embodiment is provided merely as one non-limiting example and, in other embodiments, decoded values 318 may be provided as a vector of any suitable dimension. Further, note that, during the training process, decoder layer 308 may be trained (optionally together with encoder layer 306) based on a corpus of training data with labeled training examples of address/coordinate pairs in which parameters for the various nodes in the decoder layer 308 (and, optionally, encoder layer 306) are iteratively adjusted such that the error between the actual and predicted geographic coordinates is reduced through back propagation.

In the depicted embodiment, the decoded values 318 are then passed to the output layer 310, which, in various embodiments, is operable to convert the decoded values 318 into the geographic coordinates 204. In various embodiments, the output layer 310 is operable to de-normalize one or more of the decoded values 318 to generate the geographic coordinates 204. As one non-limiting example, in the depicted embodiment, there are two decoded values 318, decoded value 318A (“0.613”) corresponding to a latitude value for the address, and decoded value 318B (“0.091”) corresponding to a longitude value for the address. In this non-limiting example, output layer 310 is operable to convert these first and second decoded values 318 into the geographic coordinates for the address using Equations 1 and 2, provided below:

Latitude=(Decoded Value 318A*360)−180 (1)

Longitude=(Decoded Value 318B*180)−90 (2)

Note, however, that this embodiment is provided merely as one non-limiting example and, in other embodiments, various other suitable techniques may be used to convert the decoded values 318 into the geographic coordinates 204.

In FIG. 4, block diagram 400 depicts an example encoder layer 306 of a machine learning model 112, according to some embodiments. As noted above, in various embodiments, encoder layer 306 is operable to generate comparative vectors 316 based on word-embedding values 314 received from the embedding layer 304. These comparative vectors 316, in various embodiments, may then be passed as input to the decoder layer 308, as described above.

In various embodiments, encoder layer 306 may be implemented as one or more ANN, including a deep neural network, using any of various ANN architectures, such as feed-forward networks (e.g., multi-layer perceptron networks, convolutional neural networks, etc.), RNNs (e.g., LSTM networks, gated recurrent unit (“GRU”) networks, etc.) or bi-directional RNNs (e.g., Bi-LSTM networks, etc.). As indicated in FIG. 4, encoder layer 306 may include multiple sub-layers, which may use the same or different network architectures in the different sub-layers. That is, in some embodiments, each of the encoder layers 306A-306N may use the same network architecture while, in other embodiments, two or more of the encoder layers 306A-306N may use differing network architectures, as desired. In one non-limiting embodiment, encoder layer 306 may be implemented using three sub-layers 306A-306C, though any suitable number of sub-layers may be used according to different embodiments. (Note that, in some embodiments, encoder layer 306 may be implemented as a single layer and, as such, not include any sub-layers).

In FIG. 4, block diagram 400 depicts additional detail regarding the structure of encoder layer 306A, which, in the non-limiting embodiment of FIG. 4, is implemented using a Bi-LSTM ANN. For example, in the depicted embodiment, encoder layer 306A includes LSTM cells arranged to form an LSTM RNN 402A and LSTM RNN 402B, with the input sequence for the two LSTM RNN 402A-402B structured such that the encoder layer 306A forms a Bi-LSTM. In this example embodiment, the input sequence (e.g., the numerical values of the N-dimensional word-embedding vectors 314) are processed in both a forward and backwards direction. As will be appreciated by one of skill in the art with the benefit of this disclosure, bi-directional RNNs (such as a Bi-LSTM) may be particularly useful for analyzing sequential data (such as the address elements in an address) by allowing the ANN to process the input data utilizing information from past and future states of the input sequence. For example, in some embodiments, encoder layer 306A is operable to process the N-dimensional word-embedding values 314 in both a forward direction (e.g., by LSTM RNN 402A) and a backwards direction (e.g., by LSTM RNN 402B) and combine the output of the two LSTM RNNs 402 (e.g., through concatenation, summation, or any other suitable combination technique).

### Example Methods

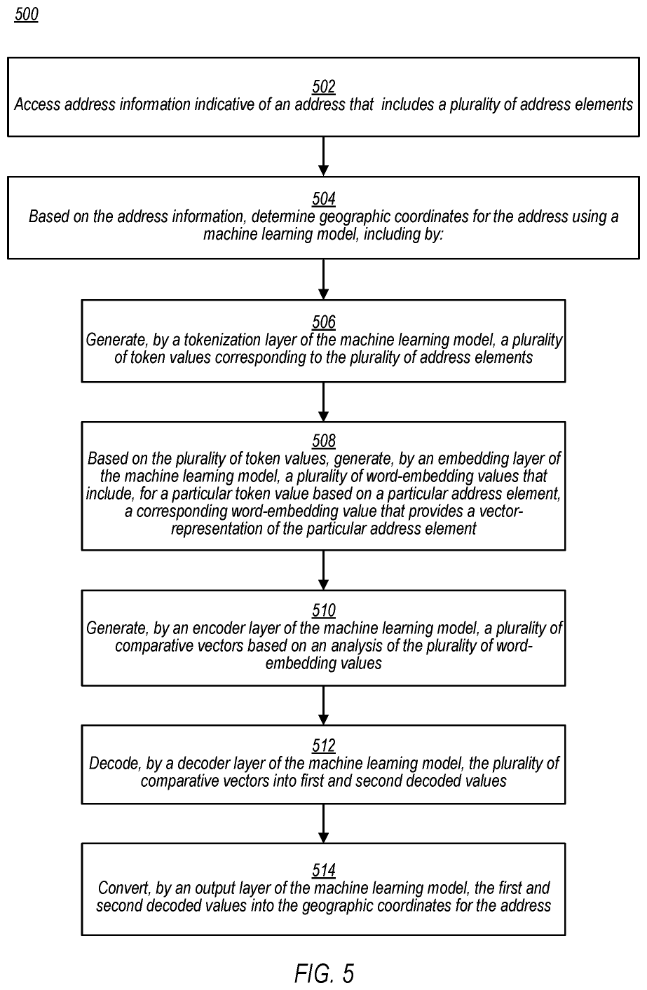

Referring now to FIG. 5, a flow diagram illustrating an example method 500 for using machine learning techniques to determine geographic coordinates for an address is depicted, according to some embodiments. In various embodiments, method 500 may be performed by server system 102 of FIGS. 1-2 to determine geographic coordinates for an address of the user 124 of client device 120 based on the address information 132 provided in the request 130. For example, server system 102 may include (or have access to) a non-transitory, computer-readable medium having program instructions stored thereon that are executable by one or more computers (e.g., hosts) within server system 102 to cause the operations described with reference to FIG. 5. In FIG. 5, method 500 includes elements 502-514. While these elements are shown in a particular order for ease of understanding, other orders may be used. In various embodiments, some of the method elements may be performed concurrently, in a different order than shown, or may be omitted. Additional method elements may also be performed as desired. Any computer system may execute all or a portion of method 500 according to various embodiments.

At 502, in the illustrated embodiment, the coordinate determination module 106 accesses address information indicative of an address that includes a plurality of address elements. For example, as discussed above with reference to FIG. 2, coordinate determination module 106 may receive address information 132 that specifies an address that includes multiple address elements. At 504, in the illustrated embodiment, the coordinate determination module 106 determines geographic coordinates for the address based on the address information. In various embodiments, coordinate determination module 106 determines the geographic coordinates using machine learning model 112. In the depicted embodiment, element 504 includes sub-elements 506-514. Note, however, that this depicted embodiment is provided merely as one non-limiting example, and, in other embodiments, element 504 may include additional, fewer, or different sub-elements, as desired.

At 506, in the illustrated embodiment, a tokenization layer 302 of the machine learning model 112 generates a plurality of token values 312 corresponding to the address elements in the address. For example, as described above with reference to FIG. 3, tokenization layer 302, in various embodiments, is operable to generate a token value 312 for one or more of the address elements included in the address information 132. In some embodiments, generating the plurality of token values 312 includes determining, for a particular address element of the plurality of address elements, a particular token value that corresponds to a frequency with which the particular address element appears in a corpus of address data. In one non-limiting embodiment, tokenization layer 302 generates the token values 312 as TF-IDF values (though other suitable techniques may also be used). For example, in some embodiments, method 500 further includes training the tokenization layer of the machine learning model based on a corpus of address data using TF-IDF, and generating the plurality of token values 312 includes applying the plurality of address elements to the trained tokenization layer 302.

At 508, in the illustrated embodiment, an embedding layer 304 of the machine learning model 112 generates a plurality of word-embedding values 314 based on the plurality of token values 312. In the depicted embodiment, the word-embedding values 314 include, for a particular token value based on a particular address element, a corresponding word-embedding value that provides a vector-representation of the particular address element. In some embodiments, method 500 further includes training the embedding layer 304 of the machine learning model 112 based on a corpus of text-based data in a first language such that, after the training, the embedding layer 304 is operable to generate word-embedding values 314 from token values 312 generated based on input text provided in the first language.

At 510, in the illustrated embodiment, an encoder layer 306 of the machine learning model 112 generates a plurality of comparative vectors 316 based on an analysis of the plurality of word-embedding values 314. In some embodiments, method 500 further includes training the encoder layer 306 of the machine learning model 112 based on a corpus of coordinate data that includes a plurality of training examples, where a given one of the plurality of training examples includes first address information and corresponding first geographic coordinates. As described above with reference to FIG. 4, in some embodiments, the encoder layer 306 includes a Bi-LSTM ANN that, once trained, is operable to analyze a sequence of the plurality of word-embedding values in both a forward direction and a backwards direction.

At 512, in the illustrated embodiment, a decoder layer 308 of the machine learning model 112 decodes the plurality of comparative vectors 316 into first and second decoded values 318. As noted above, in some embodiments, the decoder layer 308 includes a fully connected ANN (potentially in addition to one or more other ANN layers). In some such embodiments, the fully connected ANN includes a first node that is operable to apply a first activation function, to one or more input values for the first node, to generate the first decoded value, where the first decoded value corresponds to the latitude value for the address. Further, in some embodiments, the fully connected ANN includes a second node that is operable to apply a second (potentially different) activation function, to one or more input values for the second node, to generate the second decoded value, where the second decoded value corresponds to the longitude value for the address.

At 514, in the illustrated embodiment, an output layer 310 of the machine learning model 112 converts the first and second decoded values 318 into the geographic coordinates 204 for the address. For example, as discussed above with reference to FIG. 3, in some embodiments, the output layer 310 is operable to convert the first and second decoded values 318 into the geographic coordinates 204 by de-normalizing the first decoded value into the latitude value for the address and de-normalizing the second decoded value into the longitude value for the address.

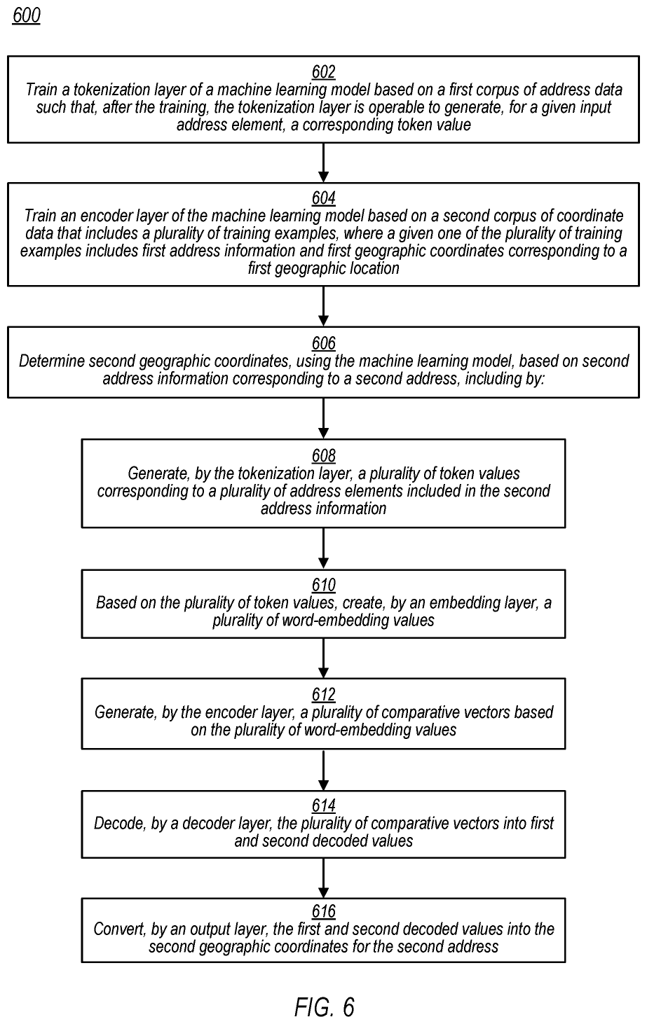

Referring now to FIG. 6, a flow diagram illustrating an example method 600 for training a machine learning model and using the trained machine learning model to determine geographic coordinates for an address is depicted, according to some embodiments. In various embodiments, method 600 may be performed by server system 102 of FIGS. 1-2 to determine whether to train a machine learning model 112 and use the trained machine learning model 112 to determine geographic coordinates 204 for an address of user 124. For example, server system 102 may include (or have access to) a non-transitory, computer-readable medium having program instructions stored thereon that are executable by one or more computers (e.g., hosts) within server system 102 to cause the operations described with reference to FIG. 6. In FIG. 6, method 600 includes elements 602-616. While these elements are shown in a particular order for ease of understanding, other orders may be used. In various embodiments, some of the method elements may be performed concurrently, in a different order than shown, or may be omitted. Additional method elements may also be performed as desired. Any computer system may execute all or a portion of method 600 according to various embodiments.

At 602, in the illustrated embodiment, training module 220 trains a tokenization layer 302 of the machine learning model 112 based on the first corpus of address data such that, after the training, tokenization layer is operable to generate, for a given input address element, a corresponding token value. In some embodiments, training the tokenization layer 302 includes using the TextRank algorithm to analyze the first corpus of address data (though various other suitable algorithms may be used, according to different embodiments). At 604, in the illustrated embodiment, training module 220 trains an encoder layer 306 of the machine learning model 112 based on a second corpus of coordinate data that includes a plurality of training examples, where a given one of the plurality of training examples includes first address information and corresponding first geographic coordinates.

At 606, in the illustrated embodiment, the coordinate determination module 106 determines second geographic coordinates, using the machine learning model 112, based on second address information corresponding to a second address. In the depicted embodiment, element 606 includes sub-elements 608-616. Note, however, that this embodiment is provided merely as one non-limiting example. In other embodiments, element 606 may include additional, fewer, or different sub-elements, as desired. At 608, in the illustrated embodiment, the tokenization layer 302 generates a plurality of token values 312 corresponding to a plurality of address elements included in the second address. In some embodiments, generating the plurality of token values 312 includes determining, for a particular address element of the plurality of address elements, a particular token value indicating a frequency with which the particular address element appears in the first corpus of address data.

At 610, in the illustrated embodiment, an embedding layer 304 creates a plurality of word-embedding values 314 based on the plurality of token values 312. In some embodiments, method 600 further includes training (e.g., by the training module 220) the embedding layer 304 of the machine learning model 112 based on a corpus of text-based data in a first language such that, after the training, the embedding layer 304 is operable to generate word-embedding values 314 from token values 312 generated based on input text provided in the first language. At 612, in the illustrated embodiment, the encoder layer 306 generates a plurality of comparative vectors 316 based on the plurality of word-embedding values 314. As noted above with reference to FIG. 3, in some embodiments, the encoder layer includes a gated recurrent unit (GRU) ANN. At 614, in the illustrated embodiment, a decoder layer 308 decodes the plurality of comparative vectors 316 into first and second decoded values 318. In some non-limiting embodiments, the decoder layer 308 is an ANN that includes one or more dropout layers. At 616, in the illustrated embodiment, an output layer 310 converts the first and second decoded values 318 into the second geographic coordinates 204 for the second address.

In some embodiments, method 600 further includes using the second geographic coordinates 204 to determine whether to authorize a transaction via the server system 102. As used herein, the term “transaction” broadly refers to any computing activity that requires authorization prior to completion. Non-limiting embodiments of transactions include accessing a user account, accessing or modifying data maintained by a server system, requesting a particular web resource, etc. Note that the transactions that may be performed via a given web service will vary depending on the nature of the web service. For example, in instances in which a server system provides email services, transactions may include accessing an email inbox, sending an email, etc. Further note that the term “transaction” may include computing activity that is financial or non-financial in nature. For example, in embodiments in which a server system provides an online payment service, the server system may be capable of performing both financial transactions (e.g., transferring funds) and transactions that are not inherently financial in nature (e.g., accessing a user account, modifying account information, etc.). Throughout this disclosure, the term “financial transaction” will be used to refer to a transaction that is financial in nature. In some embodiments, method 600 includes receiving a request to perform a transaction associated with a user account, where the request includes the second address information for the second address. In some such embodiments, method 600 includes determining whether to authorize the transaction, including by accessing third geographic coordinates that correspond to the second address and are based on an IP address of a client device used to send the request, generating an output value indicating a similarity between the second and third geographic coordinates based on a comparison of the second and third geographic coordinates, and comparing the output value to a particular threshold value to determine whether to authorize the transaction.

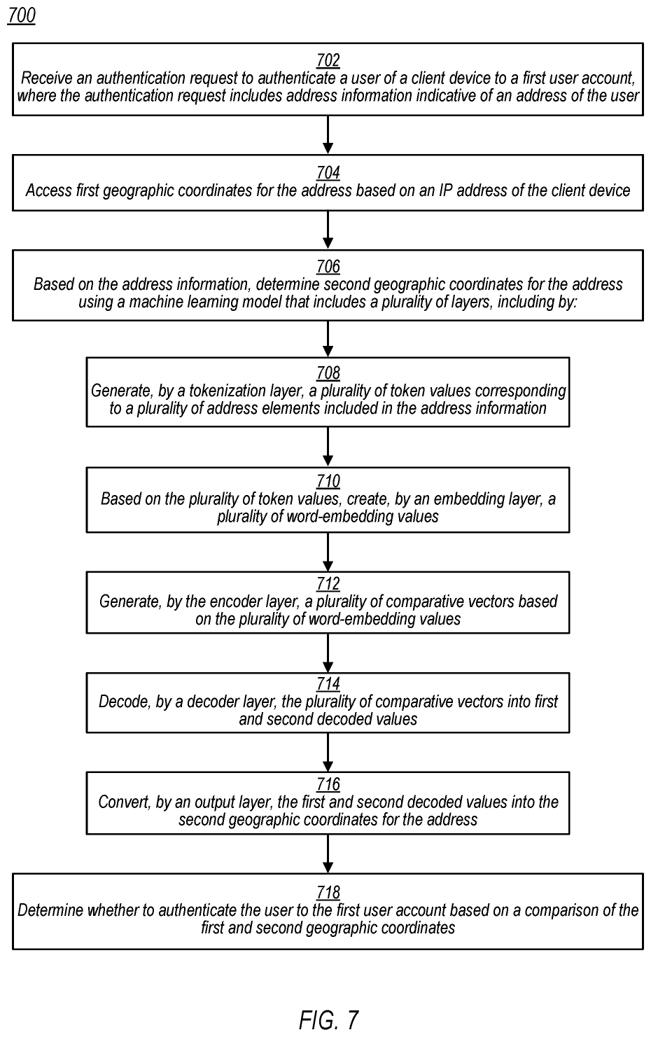

Referring now to FIG. 7, a flow diagram illustrating an example method 700 for using machine learning techniques to perform user authentication is depicted, according to some embodiments. In various embodiments, method 700 may be performed by server system 102 of FIGS. 1-2 to determine whether to authenticate a user 124 to a user account 116. For example, server system 102 may include (or have access to) a non-transitory, computer-readable medium having program instructions stored thereon that are executable by one or more computers (e.g., hosts) within server system 102 to cause the operations described with reference to FIG. 7. In FIG. 7, method 700 includes elements 702-718. While these elements are shown in a particular order for ease of understanding, other orders may be used. In various embodiments, some of the method elements may be performed concurrently, in a different order than shown, or may be omitted. Additional method elements may also be performed as desired. Any computer system may execute all or a portion of method 700 according to various embodiments.

At 702, in the illustrated embodiment, the server system 102 receives an authentication request 130 to authenticate a user 124 of a client device 120 to a first user account 116, where the authentication request 130 includes address information 132 indicative of an address of the user 124. At 704, in the illustrated embodiment, the server system 102 accesses first geographic coordinates 205 for the address based on an IP-address of the client device 120. At 706, in the illustrated embodiment, the server system 102 determines, based on the address information, second geographic coordinates 204 for the address using a machine learning model 112 that includes a plurality of layers (e.g., layers 302-310 of FIG. 3). In the depicted embodiment, element 706 includes sub-elements 708-716. Note, however, that this embodiment is provided merely as one non-limiting example. In other embodiments, additional, fewer, or different sub elements may be performed as part of element 706, as desired.

At 708, in the illustrated embodiment, a tokenization layer 302 generates a plurality of token values 312 corresponding to a plurality of address elements included in the address information 132. In some embodiments, generating the plurality of token values 312 includes determining, for a particular address element of the plurality of address elements, a particular token value that corresponds to a frequency with which the particular address element appears in a corpus of address data. At 710, in the illustrated embodiment, an embedding layer 304 creates a plurality of word-embedding values 314 based on the plurality of token values 312. At 712, in the illustrated embodiment, the encoder layer 306 generates a plurality of comparative vectors 316 based on the plurality of word-embedding values 314. As noted above, in some embodiments, the encoder layer 306 includes a Bi-LSTM ANN, and method 700 further includes training the encoder layer 306 based on a corpus of coordinate data such that, once trained, the encoder layer 306 is operable to analyze a sequence of the plurality of word-embedding values 314 in a forward direction and a backward direction to generate the plurality of comparative vectors 316. At 714, in the illustrated embodiment, a decoder layer 308 decodes the plurality of comparative vectors 316 into first and second decoded values 318. In some embodiments, at least a portion of the decoder layer 308 includes a fully connected ANN. At 716, in the illustrated embodiment, an output layer 310 converts the first and second decoded values 318 into the second geographic coordinates 204 for the address. At 718, in the illustrated embodiment, the server system 102 determines whether to authenticate the user to the first user account based on a comparison of the first and second geographic coordinates 205 and 204, respectively.

### Example Computer System

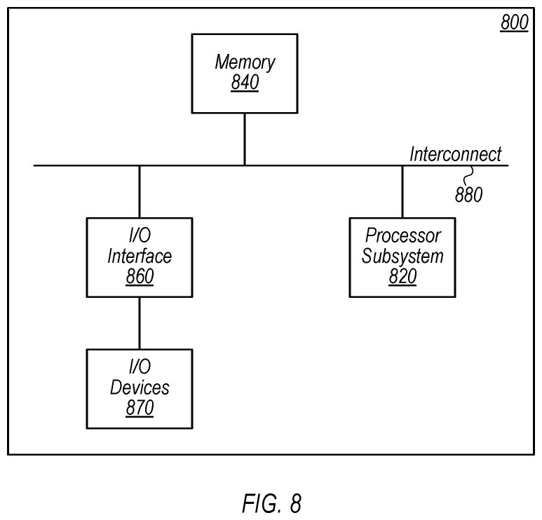

Referring now to FIG. 8, a block diagram of an example computer system 800 is depicted, which may implement one or more computer systems, such as server system 102 of FIG. 1, according to various embodiments. Computer system 800 includes a processor subsystem 820 that is coupled to a system memory 840 and I/O interfaces(s) 860 via an interconnect 880 (e.g., a system bus). I/O interface(s) 860 is coupled to one or more I/O devices 870. Computer system 800 may be any of various types of devices, including, but not limited to, a server computer system, personal computer system, desktop computer, laptop or notebook computer, mainframe computer system, server computer system operating in a datacenter facility, tablet computer, handheld computer, workstation, network computer, etc. Although a single computer system 800 is shown in FIG. 8 for convenience, computer system 800 may also be implemented as two or more computer systems operating together.

Processor subsystem 820 may include one or more processors or processing units. In various embodiments of computer system 800, multiple instances of processor subsystem 820 may be coupled to interconnect 880. In various embodiments, processor subsystem 820 (or each processor unit within 820) may contain a cache or other form of on-board memory.

System memory 840 is usable to store program instructions executable by processor subsystem 820 to cause system 800 perform various operations described herein. System memory 840 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 800 is not limited to primary storage such as system memory 840. Rather, computer system 800 may also include other forms of storage such as cache memory in processor subsystem 820 and secondary storage on I/O devices 870 (e.g., a hard drive, storage array, etc.). In some embodiments, these other forms of storage may also store program instructions executable by processor subsystem 820.

I/O interfaces 860 may be any of various types of interfaces configured to couple to and communicate with other devices, according to various embodiments. In one embodiment, I/O interface 860 is a bridge chip (e.g., Southbridge) from a front-side to one or more back-side buses. I/O interfaces 860 may be coupled to one or more I/O devices 870 via one or more corresponding buses or other interfaces. Examples of I/O devices 870 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 870 includes a network interface device (e.g., configured to communicate over WiFi, Bluetooth, Ethernet, etc.), and computer system 800 is coupled to a network via the network interface device.

Although the embodiments disclosed herein are susceptible to various modifications and alternative forms, specific embodiments are shown by way of example in the figures and are described herein in detail. It should be understood, however, that figures and detailed description thereto are not intended to limit the scope of the claims to the particular forms disclosed. Instead, this application is intended to cover all modifications, equivalents and alternatives falling within the spirit and scope of the disclosure of the present application as defined by the appended claims. The headings used herein are for organizational purposes only and are not meant to be used to limit the scope of the description.

This disclosure includes references to “one embodiment,” “a particular embodiment,” “some embodiments,” “various embodiments,” “an embodiment,” etc. The appearances of these or similar phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. As used herein, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only and is not intended to be limiting. As used herein, the singular forms “a,” “an,” and “the” include singular and plural referents unless the context clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be described or claimed as “configured” to perform one or more tasks or operations. This formulation [entity] configured to [perform one or more tasks] is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Should Applicant wish to invoke Section 112(f) during prosecution, it will recite claim elements using the “means for” [performing a function] construct.

In this disclosure, various “modules” operable to perform designated functions are shown in the figures and described in detail above (e.g., coordinate determination module 106, authentication module 108, prediction module 202, comparator 206, etc.). As used herein, the term “module” refers to circuitry configured to perform specified operations or to physical, non-transitory computer-readable media that stores information (e.g., program instructions) that instructs other circuitry (e.g., a processor) to perform specified operations. Such circuitry may be implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
accessing, by a computer system, address information indicative of an address that includes a plurality of address elements;
based on the address information, determining, by the computer system, geographic coordinates for the address using a machine learning model, including by:
generating, by a tokenization layer of the machine learning model, a plurality of token values corresponding to the plurality of address elements;
based on the plurality of token values, creating, by an embedding layer of the machine learning model, a plurality of word-embedding values that includes, for a particular token value based on a particular address element, a corresponding word-embedding value that provides a vector-representation of the particular address element;
generating, by an encoder layer of the machine learning model, a plurality of comparative vectors based on an analysis of the plurality of word-embedding values;
decoding, by a decoder layer of the machine learning model, the plurality of comparative vectors into first and second decoded values; and
converting, by an output layer of the machine learning model, the first and second decoded values into the geographic coordinates for the address.

2. The method of claim 1, wherein the generating the plurality of token values by the tokenization layer includes:
determining, for the particular address element of the plurality of address elements, the particular token value that corresponds to a frequency with which the particular address element appears in a corpus of address data.

3. The method of claim 1, further comprising:
training, by the computer system, the encoder layer of the machine learning model based on a corpus of coordinate data that includes a plurality of training examples, wherein a given one of the plurality of training examples includes first address information and corresponding first geographic coordinates.

4. The method of claim 3, wherein the encoder layer includes a bi-directional long short-term memory (Bi-LSTM) artificial neural network (ANN) that, once trained, is operable to analyze a sequence of the plurality of word-embedding values in a forward direction and a backward direction.

5. The method of claim 1, wherein the decoder layer includes a fully connected ANN.

6. The method of claim 5, wherein the fully connected ANN includes:
a first node operable to apply a first activation function, to one or more input values for the first node, to generate the first decoded value, wherein the first decoded value corresponds to a latitude value for the address; and
a second node operable to apply a second activation function, to one or more input values for the second node, to generate the second decoded value, wherein the second decoded value corresponds to a longitude value for the address.

7. The method of claim 6, wherein the converting the first and second decoded values into the geographic coordinates includes:
de-normalizing the first decoded value into the latitude value for the address; and
de-normalizing the second decoded value into the longitude value for the address.

8. The method of claim 1, further comprising:
training, by the computer system, the tokenization layer of the machine learning model based on a corpus of address data using term frequency-inverse document frequency (TF-IDF);
wherein the generating the plurality of token values includes applying the plurality of address elements to the trained tokenization layer.

9. The method of claim 1, further comprising:
training, by the computer system, the embedding layer of the machine learning model based on a corpus of text-based data in a first language such that, after the training, the embedding layer is operable to generate word-embedding values from token values generated based on input text provided in the first language.

10. A non-transitory, computer-readable medium having instructions stored thereon that are executable by a computer system to perform operations comprising:
training a tokenization layer of a machine learning model based on a first corpus of address data such that, after the training, the tokenization layer is operable to generate, for a given input address element, a corresponding token value;
training an encoder layer of the machine learning model based on a second corpus of coordinate data that includes a plurality of training examples, wherein a given one of the plurality of training examples includes, for a first address, first address information and corresponding first geographic coordinates; and
determining second geographic coordinates, using the machine learning model, based on second address information corresponding to a second address, including by:
generating, by the tokenization layer, a plurality of token values corresponding to a plurality of address elements included in the second address;
based on the plurality of token values, creating, by an embedding layer, a plurality of word-embedding values;
generating, by the encoder layer, a plurality of comparative vectors based on the plurality of word-embedding values;
decoding, by a decoder layer, the plurality of comparative vectors into first and second decoded values; and
converting, by an output layer, the first and second decoded values into the second geographic coordinates for the second address.

11. The non-transitory, computer-readable medium of claim 10, wherein the operations further comprise:
training the embedding layer of the machine learning model based on a corpus of text-based data in a first language such that, after the training, the embedding layer is operable to generate word-embedding values from token values generated based on input text provided in the first language.

12. The non-transitory, computer-readable medium of claim 10, wherein the generating the plurality of token values includes:
determining, for a particular address element of the plurality of address elements, a particular token value corresponding to a frequency with which the particular address element appears in the first corpus of address data.

13. The non-transitory, computer-readable medium of claim 12, wherein the training the tokenization layer includes using the TextRank algorithm to analyze the first corpus of address data.

14. The non-transitory, computer-readable medium of claim 10, wherein the encoder layer includes a gated recurrent unit (GRU) ANN.

15. The non-transitory, computer-readable medium of claim 10, wherein the decoder layer is an ANN that includes one or more dropout layers.

16. The non-transitory, computer-readable medium of claim 10, wherein the operations further comprise:
receiving a request to perform a transaction associated with a user account, wherein the request includes the second address information for the second address; and
determining whether to authorize the transaction, including by:
accessing third geographic coordinates that correspond to the second address and are based on an IP address of a client device used to send the request;
based on a comparison of the second and third geographic coordinates, generating an output value indicating a similarity between the second and third geographic coordinates; and
comparing the output value to a particular threshold value to determine whether to authorize the transaction.

17. A method, comprising:
receiving, by a computer system, an authentication request to authenticate a user of a client device to a first user account, wherein the authentication request includes address information indicative of an address of the user;
accessing, by the computer system, first geographic coordinates for the address that are based on an IP address of the client device;
based on the address information, determining, by the computer system, second geographic coordinates for the address using a machine learning model that includes a plurality of layers, including by:
generating, by a tokenization layer, a plurality of token values corresponding to a plurality of address elements included in the address;
based on the plurality of token values, creating, by an embedding layer, a plurality of word-embedding values;
generating, by an encoder layer, a plurality of comparative vectors based on the plurality of word-embedding values;
decoding, by a decoder layer, the plurality of comparative vectors into first and second decoded values; and
converting, by an output layer, the first and second decoded values into the second geographic coordinates for the address; and
determining, by the computer system, whether to authenticate the user to the first user account based on a comparison of the first and second geographic coordinates.

18. The method of claim 17, wherein the generating the plurality of token values includes:
determining, for a particular address element of the plurality of address elements, a particular token value corresponding to a frequency with which the particular address element appears in a corpus of address data.

19. The method of claim 18, wherein the encoder layer includes a Bi-LSTM ANN, wherein the method further comprises:
training, by the computer system, the encoder layer based on a corpus of coordinate data such that, once trained, the encoder layer is operable to analyze a sequence of the plurality of word-embedding values in a forward direction and a backward direction to generate the plurality of comparative vectors.

20. The method of claim 19, wherein at least a portion of the decoder layer includes a fully connected ANN.
